(19) United States
(12) Patent Application Publication
(10) Pub. No.: US 2026/0111527 A1
(43) Pub. Date: Apr. 23, 2026

(54) TAMPER DETECTION FOR ELECTRONIC DEVICES USING PHYSICAL CHARACTERISTIC FINGERPRINTING

(71) Applicant: SEAGATE TECHNOLOGY LLC, Fremont, CA (US)

(72) Inventors: Foo Yee Yeo, Shugart (SG); Saravanan Nagarajan, Shugart (SG); Kian Beng Lim, Shugart (SG); Jason Hwei Ming Ying, Shugart (SG)

(21) Appl. No.: 18/919,928

(22) Filed: Oct. 18, 2024

(51) Int. Cl. G06F 21/44; G06F 21/73

(52) U.S. Cl. CPC G06F 21/44; G06F 21/73

(57) ABSTRACT

Disclosed are methods for electronic device authentication in which distinguishing physical characteristics of electronic devices are converted into unique identification strings (UIDs) that can be used like fingerprints to verify device authenticity. Such methods may be used for tamper detection, for example in combatting warranty fraud. UIDs may be generated from physical characteristics that are unique to a given device, such as imperfections on the device exterior or unique aspects of a circuit board. Images of the device in selected areas or at selected angles may be captured and provided to an algorithm that converts the physical characteristics of the physical device into a UID, for example making use of a fuzzy extractor. When a device is presented for authentication, images of the device may be similarly converted into a verification string that can be checked against the UID.

### TECHNICAL FIELD

The disclosure relates to tamper detection and device authentication techniques using physical characteristics.

### SUMMARY

In accordance with certain aspects, the present disclosure describes methods for uniquely identifying electronic devices, such as hard disk drives to facilitate device authentication. Such methods may include capturing one or more images of distinguishing physical features of the electronic device, converting the one or more images into an identification string unique to the electronic device using an algorithm that includes a fuzzy extractor, and associating the identification string unique to the electronic device with additional information about the electronic device. The identification string unique to the electronic device and the additional information about the electronic device may be stored in a securely retrievable fashion to thereby facilitate authentication of the electronic device.

In certain aspects, converting the one or more images into an identification string unique to the electronic device involves concatenating data strings generated from multiple images of the electronic device.

In certain aspects, storing the identification string unique to the electronic device includes storing in a database or providing identification string information on a label attached to the electronic device. In certain aspects, the methods also include providing a digital signature on the label to further facilitate authentication of the electronic device.

In certain aspects, at least a portion of the distinguishing physical features reside on an exterior of the electronic device, on a circuit board of the electronic device, or on or near attachment features of the electronic device.

In certain aspects, the additional information about the electronic device includes one or more of electronic device brand, name, model, size, serial number, or public key.

In accordance with certain aspects, the present disclosure describes methods for authenticating electronic devices, such as hard disk drives. Such methods may include capturing one or more images of distinguishing physical features of an electronic device, converting the one or more images into a verification string using an algorithm that includes a fuzzy extractor, and determining electronic device authenticity by checking the verification string against a stored unique identification string generated using the same algorithm used to generate the verification string.

In certain aspects, converting the one or more images into a verification string involves concatenating data strings generated from multiple images of the electronic device.

In certain aspects, the unique identification string is stored in a database or printed on a label attached to the electronic device.

In certain aspects, determining electronic device authenticity further involves checking a digital signature provided with the electronic device. For example, the digital signature may be printed on a label attached to the electronic device.

In certain aspects, the distinguishing physical features include imperfections on an exterior surface of the electronic device, characteristics of a circuit board of the electronic device, or imperfections on or around attachment features of the electronic device.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

FIG. 1 is a schematic perspective view of the front of an example hard disk drive device.

FIG. 2 is a schematic view of the back of an example hard disk drive device.

FIG. 3 is a schematic representation of an example label for a hard disk drive device.

FIG. 4 is a block diagram representing device verification using physical characteristic fingerprinting in accordance with aspects of the present disclosure.

FIG. 5 is a flow chart depicting steps for using physical characteristic fingerprinting for device authentication in accordance with aspects of the present disclosure.

### DETAILED DESCRIPTION

The present disclosure relates to tamper detection for electronic devices, for example to combat warranty fraud. Unique identification strings (UIDs) may be generated for each device so that devices can later be verified against the UIDs. Physical characteristics unique to each device, such as imperfections on the device exterior or unique aspects of a circuit board, may be converted into a UID for that device. Images of the device in selected areas or at selected angles may be captured and provided to an algorithm that converts the physical characteristics of the physical device into a UID, for example making use of a fuzzy extractor. In certain aspects, it may be useful to select for image capture those areas of the device that might be altered by attempted tampering and/or that are likely to appear different for each device.

By generating UIDs for device authentication in this manner, any tampering with a device will be highly likely, if not assured, to result in the inability to verify the identity or authenticity of that device, thus indicating that tampering has occurred. UIDs may be data strings obtained from a single image of a selected area of a device, or may be a concatenation of data strings obtained from images of different areas and/or different physical features of the device. Digital signatures may also be used, whether separately or in combination with UIDs generated from device physical characteristics, whereby the digital signatures may be embedded in a QR code or other code or data string that is printed on a device label or otherwise provided on the device exterior for scanning. In certain aspects, the electronic devices may be hard disk drives.

Warranty fraud in which bad actors, also called “scammers,” submit false warranty claims on tampered products can be a significant problem for suppliers of electronic and consumer devices. In the case of hard disk drives, scammers may attempt to modify a drive of lower value (such as an older model or lower capacity drive) to disguise it as another product of higher cost (such as a newer model or higher capacity drive), thereby fraudulently redeeming it for ill-gotten gain. Scammers have shown adeptness in adapting to and evading certain warranty fraud prevention efforts such as detection of counterfeit labels. As such, it is recognized in the present disclosure that it may be beneficial to develop and deploy device authentication techniques that allow for the unique identification of electronic devices such as hard drives from distinguishing physical characteristics of the devices that are difficult or nearly impossible to mimic and/or that are likely to be altered during tampering attempts. Such authentication techniques may successfully thwart fraud even under circumstances where the bad actor is fully aware of the authentication techniques being used.

In accordance with various aspects of the present disclosure, physical characteristics or imperfections on the exterior of a device such as a hard drive may be used to create an identification for the device that cannot be easily forged by a scammer. It is natural for devices to have some imperfections, for example due to materials imperfections, manufacturing and assembly processes, and so forth, and these imperfections can be used as unique “fingerprints” of the device for identification purposes. As used throughout this disclosure, terms such as “imperfections,” “characteristics,” “features,” and similar terms may all be used to refer to distinguishing aspects or traits of the device that are physically present, detectable, and imageable, and that are unique to a given device. The mentioning of one such term without mentioning others is not meant to preclude or exclude application or use of any. Moreover, it will be understood that such features may be present on the device housing, on the device exterior, on a circuit board, or on any other part of the device that may be accessible during device authentication.

As set forth in the present disclosure, fuzzy extractors, which allow the use of biometric data such as fingerprints as inputs for cryptographic authentication techniques, may be used to convert images of physical imperfections on electronic devices into UIDs for those devices. Rather than require fixed value inputs for cryptography, fuzzy extractors can extract identification data from values close but not necessarily identical to the original key without compromising security. As such, when a device is received back for a warranty claim, for example, the physical characteristics on the returned device may be converted to a string of data that may be checked against the UID to determine whether the returned device is the same device that the claimant claims it to be.

In certain aspects, a device manufacturing or assembly facility may function as the issuer of the UID for a device by generating an identification string for each device. For example, during manufacturing, assembly, packaging, and so forth, images of a device may be captured and fed into an algorithm that uses a fuzzy extractor to convert the physical characteristics of the device into a UID for that device. The generated identification string that makes up the UID may be from a single image or may be from a concatenation of strings obtained from multiple images, for example images of different areas or of different physical characteristics of the device. The UID together with the serial number and/or other information about the device may be stored in a database that can be accessed by collection centers or other receiving agencies, or alternatively may be printed on the device label together with a digital signature to authenticate the integrity of the printed information.

When a device is returned, such as when making a warranty claim, the collection center acts as the verifier, and captures another image or set of images of the device. Such image or images may then be fed into the same algorithm that was used to generate the UID to thereby derive a verification string. If the verification string matches the identification string, then there is a high level of confidence that the device submitted by the warranty claimant matches the device that it purports to be. In other words, the device may be treated as genuine. Because imperfections are difficult to forge, the methods disclosed herein are amenable to detecting with a high degree of reliability whether a device has been forged or otherwise altered.

The use of automated algorithms that employ fuzzy extractors to thereby authenticate devices using “fingerprinting” from distinguishing physical characteristics overcomes the human subjectivity and manual labor required for inspections to be done manually in collection centers. Fuzzy extractor output is both time efficient as well as data storage efficient since images of the imperfections or other physical characteristics do not need to be stored. Moreover, device identification information can be printed on the device label, thereby negating the need to maintain a database of identification strings.

Reference will now be made to the drawings, which depict one or more aspects described in this disclosure. However, it will be understood that other aspects not depicted in the drawings fall within the scope of this disclosure. Like numbers used in the figures refer to like components, steps, and the like. However, it will be understood that the use of a reference character to refer to an element in a given figure is not intended to limit the element in another figure labeled with the same reference character. In addition, the use of different reference characters to refer to elements in different figures is not intended to indicate that the differently referenced elements cannot be the same or similar. It will also be appreciated that the drawings are meant to illustrate certain aspects and arrangements of features in a way that contributes to their understanding and are not meant to be scale drawings that accurately represent size or shape of elements.

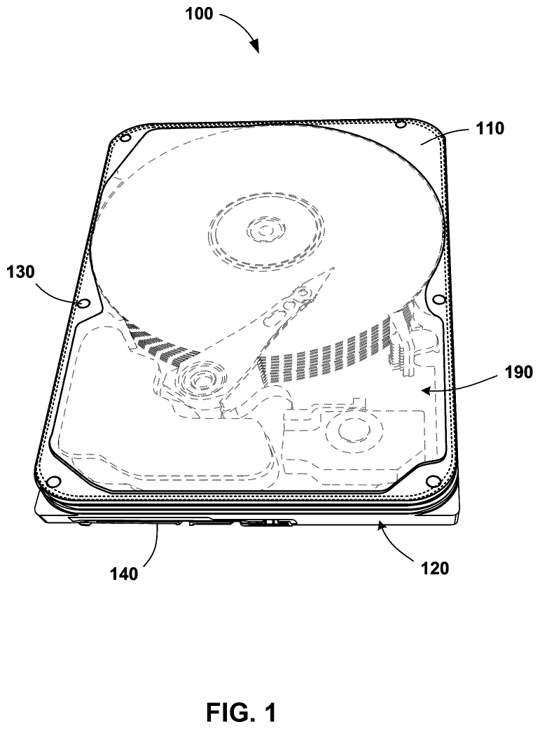

FIG. 1 shows an example of hard disk drive (HDD) device 100. The interior components of HDD 100 are indicated by dashed lines. HDD 100 can be connected to a host device and to power through an interface 140. HDD 100 is shown in a front perspective view to illustrate portions of the housing such as the front cover 110, one of the sides 120, and attachment locations 130, which may involve the use of rivets, screws, or welding. Also indicated is a flat portion 190 of the front cover 110 where a label may be located. Various areas on the sides and front of the HDD 100, and in particular around the attachment locations, may provide area for acquiring images from which to generate a UID for the device by fingerprinting imperfections or other distinguishing features. In certain aspects, images of the same area or areas of each device are captured for generation of a UID and for generation of a verification string. Having a procedure, whether automated or manual, under which images of the same areas are captured may help facilitate accuracy in device authentication.

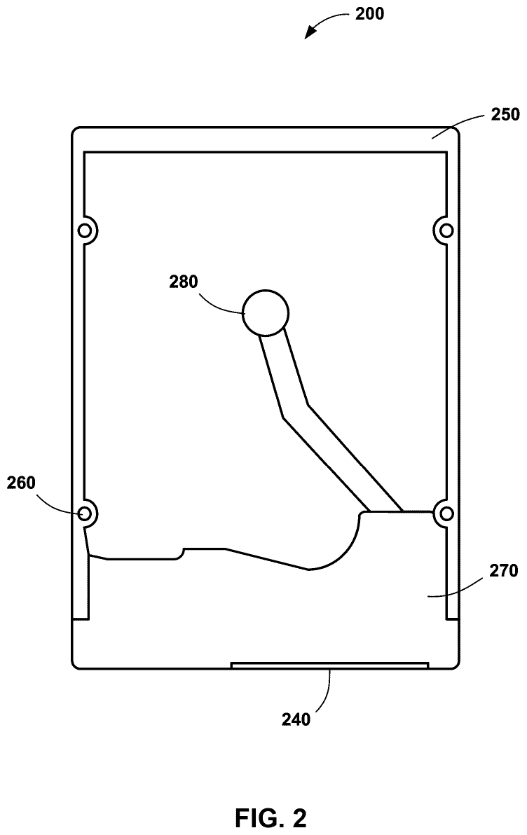

FIG. 2 shows a back surface view of an example HDD device 200, including interface 240, base 250, attachment location 260, circuit board 270, and spindle motor protrusion 280. Various of these areas, along with other areas on the exterior of the device, may serve as locations for capturing images of features unique to the device 200 for the purposes of generating a UID.

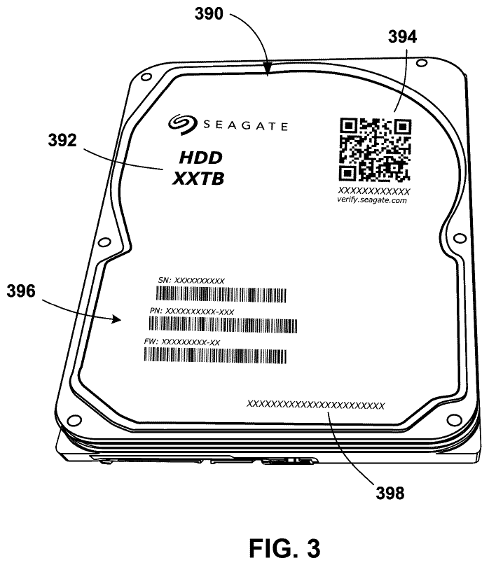

FIG. 3 shows a mock-up of an example label 390 on the front of an electronic device such as an HDD. The label 390 may have information 392 about the type of device printed in readable form such as a brand name, device name, and device size. The label 390 may include a QR code 394 and/or one or more bar codes 396 for encoding information such as serial number and other device information. The label 390 may also include additional character strings 398 that encode certain device-specific information. The UID generated for a specific device may be printed on the label 390, together with a digital signature to facilitate authentication. A copy of the UID might also be stored on a server instead of (or in addition to) printing the UID on the label itself. The QR code 394 may contain a URL for retrieval of the UID from the manufacturer's website. Various of these items such as the QR code 394, bar code(s) 396, and character string(s) 398 may also be used as digital signatures and/or to encode, or partially encode, the UID.

It is possible to employ a method for verification of any or all information printed on a device label, yet which cannot be counterfeited by a bad actor without being in possession of the device being mimicked. Such methods use a cryptographic primitive known as a digital signature. A party known as the signer has a key pair (denoted sk, pk) that consists of a private key sk and a public key pk. The signer can sign messages of his choice, and the signature can then be verified by anyone who has the public key pk. The cryptographic properties of digital signatures means that no one except the signer will be able to create a signature that passes verification. While digital signatures are typically used electronically, for example in online communications, the present disclosure appreciates that digital signatures may also be used for tamper detection. For example, a device manufacturer may have a secret key sk that is used to sign a message that includes all the information provided on the device label. The digital signature is then printed on the label itself, either as text or as a QR code or other code. A warranty claim collection center or other receiving facility that collects drives for verification will have the corresponding public key pk, and can use that to verify whether all information on the drive label is correct.

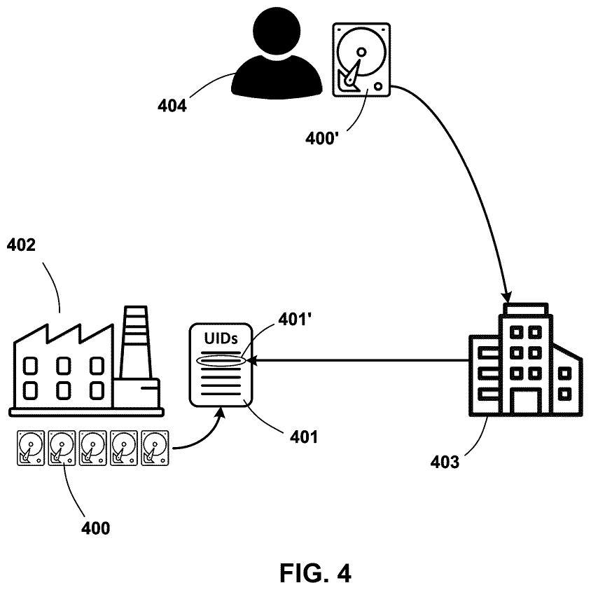

FIG. 4 is a block diagram illustrating aspects of methods of device identification and authentication using physical feature fingerprinting in accordance with the present disclosure. A manufacturing facility 402 that makes devices 400 may capture images of the device and feed those images into a fuzzy extractor enable algorithm to generate a UID uniquely associated with each device. The UIDs may be stored in a UID database 401 (such as on a server), along with any other device-specific information. The manufacturing facility 402 may also be an assembly facility, a packaging facility, a distribution facility, or the like. At some point, a consumer 404 who has possession of a particular device 400′ may wish to submit the device 400′ for a warranty claim, refund, repair, data recovery, upgrade, or other such purpose. In such as case, the device 400′ is physically provided to a receiving center 403 for processing the claim. While the device 400′ is in physical custody for processing the claim, the device 400′ may be authenticated by capturing images of the device 400′ and feeding those images into the same algorithm used to generate the UIDs. This algorithm generates a verification string that can be checked against the UID information securely held in the database by facility 402.

Alternatively, UID information can be securely retrieved from information provided on the device label. If the verification string for device 400′ matches that device's UID 401′, then the device 400′ is genuine. If not, there has been tampering or otherwise fraudulent passing off of one device as another.

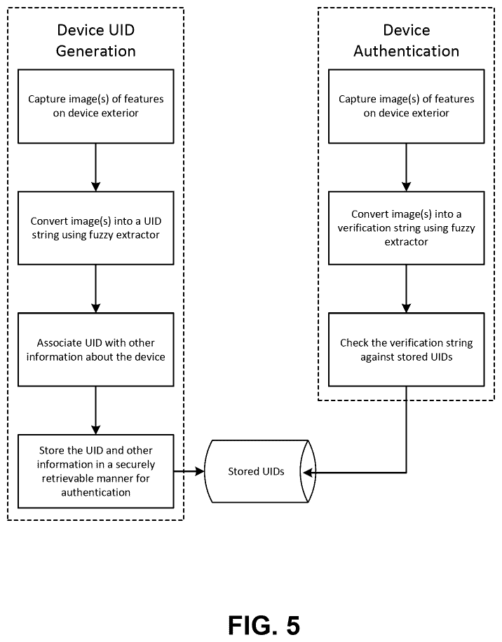

FIG. 5 shows a flow chart of steps that may be used in accordance with the present disclosure for the generation of UIDs based on distinguishing device physical characteristics, and for the authentication of devices using verification strings generated based on such physical characteristics. For device UID generation, one or more images of the device may be captured, preferably in accordance with a determined and reproducible procedure. The one or more images are converted into a UID by an algorithm enabled with a fuzzy extractor. The UID may be produced from a single identification string or by concatenation of multiple identification strings. Additional information about the device may be associated with the UID, and then the UID and additional information may be stored. Such additional information about the device may include information related to the type of device (brand, name, model, size, and so forth), identification information (such as a serial number), or authentication information (such as a public key). Storing the data may take place in a database or may be encoded into information provided on a device label. For device authentication, the same procedure may be used to capture one or more images of a device that has been received for verification. The one or more images are fed through the same algorithm used to generate UIDs for such devices, thereby producing a verification string. The verification string is then checked against stored UID information, which may be securely retrieved through accessing a database or from information provided on the device label.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (for example, all described acts or events may not be necessary to carry out the techniques). In addition, while certain aspects of this disclosure are described as being performed by a single module or unit for purposes of clarity, it should be understood that the techniques of this disclosure may be performed by a combination of units or modules.

All scientific and technical terms used herein have meanings commonly used in the art unless otherwise specified. The definitions provided herein are to facilitate understanding of certain terms used frequently herein and are not meant to limit the scope of the present disclosure.

As used herein, the term “configured to” may be used interchangeably with the terms “adapted to” or “structured to” unless the content of this disclosure clearly dictates otherwise.

As used herein, the term “or” refers to an inclusive definition, for example, to mean “and/or” unless its context of usage clearly dictates otherwise. The term “and/or” refers to one or all of the listed elements or a combination of at least two of the listed elements.

As used herein, the phrases “at least one of” and “one or more of” followed by a list of elements refers to one or more of any of the elements listed or any combination of one or more of the elements listed.

As used herein, the terms “coupled” or “connected” refer to at least two elements being attached to each other either directly or indirectly. An indirect coupling may include one or more other elements between the at least two elements being attached. Further, in one or more embodiments, one element “on” another element may be directly or indirectly on and may include intermediate components or layers therebetween. Either term may be modified by “operatively” and “operably,” which may be used interchangeably, to describe that the coupling or connection is configured to allow the components to interact to carry out described or otherwise known functionality.

As used herein, any term related to position or orientation, such as “proximal,” “distal,” “end,” “outer,” “inner,” and the like, refers to a relative position and does not limit the absolute orientation of an embodiment unless its context of usage clearly dictates otherwise.

The singular forms “a,” “an,” and “the” encompass embodiments having plural referents unless its context clearly dictates otherwise.

As used herein, “have,” “having,” “include,” “including,” “comprise,” “comprising” or the like are used in their open-ended sense, and generally mean “including, but not limited to.” It will be understood that “consisting essentially of,” “consisting of,” and the like are subsumed in “comprising,” and the like.

Reference to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

What is claimed is:

1. A method for uniquely identifying an electronic device, the method comprising:
capturing one or more images of distinguishing physical features of the electronic device;
converting the one or more images into an identification string unique to the electronic device using an algorithm that includes a fuzzy extractor;
associating the identification string unique to the electronic device with additional information about the electronic device; and
storing the identification string unique to the electronic device and the additional information about the electronic device in a securely retrievable fashion to thereby facilitate authentication of the electronic device.

2. The method of claim 1, wherein converting the one or more images into an identification string unique to the electronic device comprises concatenating data strings generated from multiple images of the electronic device.

3. The method of claim 1, wherein storing the identification string unique to the electronic device comprises storing in a database.

4. The method of claim 1, wherein storing the identification string unique to the electronic device comprises providing identification string information on a label attached to the electronic device.

5. The method of claim 4, further comprising providing a digital signature on the label to further facilitate authentication of the electronic device.

6. The method of claim 1, wherein at least a portion of the distinguishing physical features reside on an exterior of the electronic device.

7. The method of claim 1, wherein at least a portion of the distinguishing physical features reside on a circuit board of the electronic device.

8. The method of claim 1, wherein at least a portion of the distinguishing physical features reside on or near attachment features of the electronic device.

9. The method of claim 1, wherein the additional information about the electronic device includes one or more of electronic device brand, name, model, size, serial number, or public key.

10. The method of claim 1, wherein the electronic device is a hard disk drive.

11. A method for authenticating an electronic device, the method comprising:
capturing one or more images of distinguishing physical features of the electronic device;
converting the one or more images into a verification string using an algorithm that includes a fuzzy extractor; and
determining electronic device authenticity by checking the verification string against a stored unique identification string generated using the algorithm used to generate the verification string.

12. The method of claim 11, wherein converting the one or more images into a verification string comprises concatenating data strings generated from multiple images of the electronic device.

13. The method of claim 11, wherein the unique identification string is stored in a database.

14. The method of claim 11, wherein the unique identification string is stored in information provided on a label attached to the electronic device.

15. The method of claim 11, wherein determining electronic device authenticity further comprises checking a digital signature provided with the electronic device.

16. The method of claim 15, wherein the digital signature is printed on a label attached to the electronic device.

17. The method of claim 11, wherein the distinguishing physical features include imperfections on an exterior surface of the electronic device.

18. The method of claim 11, wherein the distinguishing physical features include characteristics of a circuit board of the electronic device.

19. The method of claim 11, wherein the distinguishing physical features include imperfections on or around attachment features of the electronic device.

20. The method of claim 11, wherein the electronic device is a hard disk drive.
